(19) United States
(12) Patent Application Publication
(10) Pub. No.: US 2016/0217198 A1
(43) Pub. Date: Jul. 28, 2016

(54) USER MANAGEMENT METHOD AND APPARATUS

(71) Applicant: SAMSUNG ELECTRONICS CO., LTD., Suwon-si (KR)

(72) Inventors: Kyoobin LEE, Seoul (KR); Ping GUO, Beijing (CN); Xiaotao WANG, Beijing (CN); Keun Joo PARK, Seoul (KR); Qiang WANG, Beijing (CN); Wentao MAO, Beijing (CN)

(73) Assignee: SAMSUNG ELECTRONICS CO., LTD., Suwon-si (KR)

(21) Appl. No.: 14/790,789

(22) Filed: Jul. 2, 2015

(30) Foreign Application Priority Data
Jan. 26, 2015 (KR) 10-2015-0012351

(51) Int. Cl. G06F 17/30; G06N 3/08; G06N 99/00

(52) U.S. Cl. CPC G06F 17/30598; G06F 17/30604; G06N 99/005; G06N 3/08

(57) ABSTRACT

A user management method and apparatus are provided. The user management method includes verifying whether a user included in an input image is a registered user based on a first classification model classifying the registered user; storing a feature corresponding to the user and extracted from the input image in a database in response to the user not being the registered user; generating a second classification model classifying the registered user and a candidate user corresponding to one of features stored in the database; and determining whether the candidate user is to be registered based on the second classification model.

### CROSS-REFERENCE TO RELATED APPLICATION

This application claims priority from Korean Patent Application No. 10-2015-0012351, filed on Jan. 26, 2015, in the Korean Intellectual Property Office, the disclosure of which is incorporated by reference herein in its entirety.

### BACKGROUND

1. Field

Methods and apparatuses consistent with exemplary embodiments relate to a user management method and a user management apparatus.

2. Description of the Related Art

A transition into an information-oriented society may enhance a value of information on a specific organization as well as personal information. Accordingly, development of various technologies for identifying a user as well as a password for the user has been required to protect salient information. Since facial recognition technology enables a user to be identified even when the user is unrecognized and without a need to make a particular motion or gesture, the facial recognition technology has been evaluated as a convenient and competitive identification method.

In facial recognition technology, a user may be identified by a pattern classifier for distinguishing a registered face and a non-registered face. Accordingly, the pattern classifier may need to be changed to register a new user or remove a pre-registered user.

### SUMMARY

Exemplary embodiments may address at least the above problems and/or disadvantages and other disadvantages not described above. Also, the exemplary embodiments are not required to overcome the disadvantages described above, and an exemplary embodiment may not overcome any of the problems described above.

According to an aspect of an exemplary embodiment, there is provided a user management method including verifying whether a user included in an input image is a registered user based on a first classification model classifying the registered user; storing a feature corresponding to the user and extracted from the input image in a database in response to the user not being the registered user; generating a second classification model classifying the registered user and a candidate user corresponding to one of features stored in the database; and determining whether the candidate user is to be registered based on the second classification model.

The second classification model may be generated by adding an element indicating the candidate user to an output layer of the first classification model, the output layer comprising an element indicating the registered user.

The second classification model may be generated by setting connection weights of elements indicating the registered user and the candidate user based on a feature corresponding to the registered user and a feature corresponding to the candidate user.

The generating may include determining whether the candidate user is to be registered based on a confidence indicating a degree to which the features stored in the database using the second classification model are classified as corresponding to the candidate user.

The generating may include determining whether the candidate user is to be registered based on whether a confidence of the candidate user is a greatest value among confidences of non-registered users corresponding to the features stored in the database.

The generating may include determining not to register the candidate user in response to the confidence of the candidate user being less than a threshold confidence while the confidence of the candidate user is the greatest value among the confidences of the non-registered users.

In response to a determination that the candidate user is to be registered, the method may include verifying whether a user included in an image input after the determination is the registered user based on the second classification model.

The user management method may further include updating the first classification model by using the input image based on an identification probability of the user included in the input image in response to the user being verified as the registered user.

The updating may include updating connection weights of elements included in an output layer of the first classification model based on the feature extracted from the input image.

The feature extracted from the input image may be processed through a grouping based on a time at which the input image is acquired.

The input image may include a face of a user corresponding to the input image.

According to an aspect of another exemplary embodiment, there is provided a user management method including generating, based on a first classification model classifying a registered user, a second classification model classifying the registered user and a candidate user corresponding to one of a plurality of non-registered users; determining a confidence of the candidate user and confidences of the plurality of non-registered users, based on the second classification model; and determining whether the candidate user is to be registered based on the confidences of the non-registered users and the confidence of the candidate user.

The generating may include generating the second classification model by adding an element indicating the candidate user to an output layer of the first classification model, the output layer comprising an element indicating the registered user.

The generating may include generating the second classification model by setting connection weights of elements included in the output layer based on a feature corresponding to the registered user and a feature corresponding to the candidate user.

The confidence of the candidate user may indicate a degree to which features of the plurality of non-registered users are classified as corresponding to the candidate user based on the second classification model.

The determining may include determining whether the candidate user is to be registered based on whether the confidence of the candidate user is a greatest value among the confidences of the non-registered users.

The user management method may further include verifying, in response to a determination that the candidate user is to be registered, whether a user included in an image input after the determination is the registered user based on the second classification model.

The non-registered users may be users determined to differ from the registered user based on the first classification model among users included in images input during a period of time.

According to an aspect of another exemplary embodiment, there is provided a computer program stored in a non-transitory computer-readable recording medium to implement a method through a combination with hardware, the method comprising verifying whether a user included in an input image is a registered user based on a first classification model classifying the registered user; storing a feature corresponding to the user and extracted from the input image in a database in response to the user not being the registered user; generating a second classification model classifying the registered user and a candidate user corresponding to one of features stored in the database; and determining whether the candidate user is to be registered based on the second classification model.

According to an aspect of another exemplary embodiment, there is provided a user management apparatus comprising a verifier configured to verify whether a user included in an input image is a registered user based on a first classification model classifying the registered user; a storage configured to store a feature corresponding to the user and extracted from the input image in a database in response to the user included in the input image not being the registered user; and a determiner configured to generate a second classification model classifying the registered user and a candidate user corresponding to one of features stored in the database and to determine whether the candidate user is to be registered based on the second classification model.

According to an aspect of another exemplary embodiment, there is provided a method for automatically registering a user in an input image, the method including determining whether the user included in the input image is a pre-registered user based on a first neural network classification model used to learn one or more pre-registered users; in response to determining the user is not one of the one or more pre-registered users, storing a feature corresponding to the user and extracted from the input image; generating a second neural network classification model for learning a non-registered user corresponding to one of the stored features, the second neural network classification model based on the first neural network classification model; and determining whether a candidate user among non-registered users is to be registered based on the second neural network classification model.

The first neural network classification model and the second neural network classification model may each include an output layer and a previous layer to the output layer in a deep convolutional neural network (DCNN).

The user may be registered without a request for registration from the user.

The second neural network classification model may be generated by modifying the first neural network classification model to learn the feature corresponding to the non-registered user.

### BRIEF DESCRIPTION OF THE DRAWINGS

The above and other aspects will become apparent and more readily appreciated from the following detailed description of certain exemplary embodiments, taken in conjunction with the accompanying drawings of which:

FIG. 1 illustrates an example of classifying a user by using a neural network learning based on an unsupervised learning according to an exemplary embodiment;

FIG. 2 illustrates an example of a user management apparatus according to an exemplary embodiment;

FIG. 3 illustrates a user identifier of a user management apparatus according to an exemplary embodiment;

FIG. 4 illustrates a feature extraction model extracting a feature from an input image according to an exemplary embodiment;

FIG. 5 illustrates an example of selecting a feature by using a feature extractor according to an exemplary embodiment;

FIG. 6 illustrates a classification model according to an exemplary embodiment;

FIG. 7 illustrates a method of identifying a user included in an input image using an identifier according to an exemplary embodiment;

FIG. 8 illustrates a user manager operating in an interactive mode according to an exemplary embodiment;

FIG. 9 illustrates an adaptive change in a classification model according to an exemplary embodiment;

FIG. 10 illustrates a user manager operating in an automatic mode according to an exemplary embodiment;

FIG. 11 illustrates a feature track corresponding to a non-registered user according to an exemplary embodiment;

FIG. 12 illustrates a procedure of registering a new user by using the user manager of FIG. 10 according to an exemplary embodiment;

FIG. 13 illustrates a procedure of generating a second classification model based on a first classification model according to an exemplary embodiment;

FIG. 14 illustrates a procedure of calculating a confidence of a non-registered user according to an exemplary embodiment;

FIG. 15 illustrates a user management method according to an exemplary embodiment; and

FIG. 16 illustrates another example of a user management apparatus according to an exemplary embodiment.

### DETAILED DESCRIPTION

Reference will now be made in detail to exemplary embodiments, examples of which are illustrated in the accompanying drawings, wherein like reference numerals refer to the like elements throughout. Exemplary embodiments are described below in order to explain the present disclosure by referring to the figures.

The following detailed description is provided to assist the reader in gaining a comprehensive understanding of the methods, apparatuses, and/or systems described herein. The features described herein may be embodied in different forms, and are not to be construed as being limited to the examples described herein. Various changes, modifications, and equivalents of the systems, apparatuses and/or methods described herein will be apparent to one of ordinary skill in the art. Throughout the drawings and the detailed description, the same reference numerals refer to the same elements. Also, descriptions of functions and constructions that are well known to one of ordinary skill in the art may be omitted for increased clarity and conciseness.

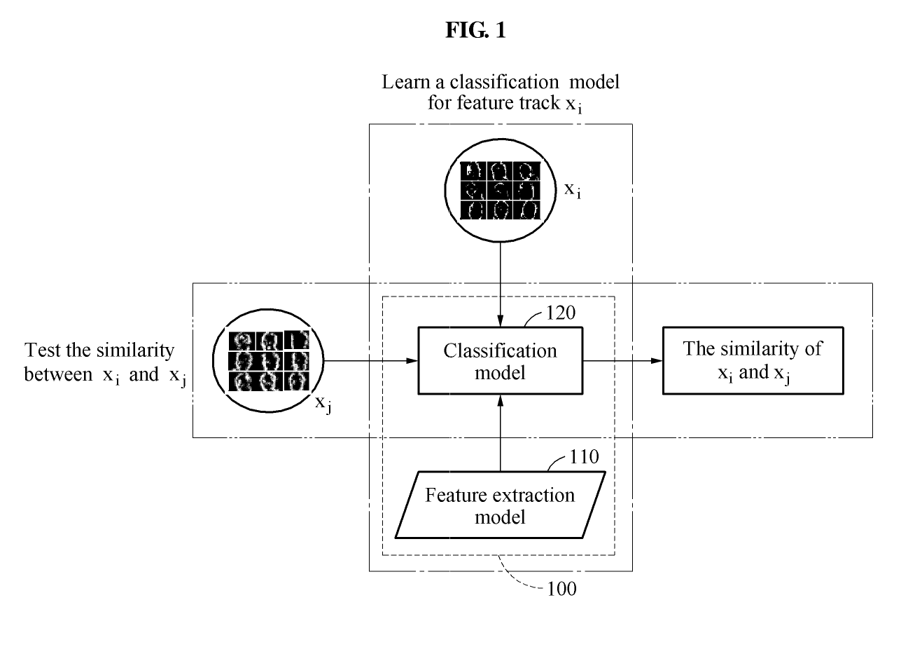

FIG. 1 illustrates an example of classifying a user by using a neural network learning based on an unsupervised learning according to an exemplary embodiment.

Referring to FIG. 1, a neural network 100 may include a feature extraction model 110 and a classification model 120. The neural network 100 may be, for example, a recognition model implemented through hardware or software imitating a computability of a biological system based on numerous artificial neurons connected using a connection line.

Artificial neurons obtained by simplifying a function of a biological neuron may be used in the neural network 100. The artificial neurons may be mutually connected through a connection line having a connection weight. The connection weight may be a predetermined value of the connection line, and also be referred to as a connection strength. The neural network 100 may perform a human cognitive interaction or learning process by using the artificial neurons. The artificial neuron may also be referred to as, for example, a node.

The neural network 100 may include an input layer, a hidden layer, and an output layer. The input layer may receive input data used for recognition or learning and transfer the input data to the hidden layer. The output layer may generate an output of the neural network 100 based on a signal received from nodes of the hidden layer. Each layer may include a plurality of nodes, and nodes disposed between neighboring layers may be mutually connected with the connection weight. Each of the nodes may operate based on an activation model. An output value corresponding to an input value may be determined based on the activation model. An output value of a predetermined node may be input to a node of a subsequent layer connected with the predetermined node. The node of the subsequent layer may receive values output from a plurality of nodes. The connection weight may be applied in a process of inputting the value output from the predetermined node to the node of the subsequent layer. The node of the subsequent layer may output a value corresponding to the input value to a node of a further subsequent layer connected to the corresponding node based on the activation model.

The neural network 100 may include a plurality of hidden layers. A neural network including a plurality of hidden layers may also be referred to as, for example, a deep neural network, and a learning of the deep neural network may also be referred to as, for example, a deep learning. The neural network 100 may be learned based on unsupervised learning. The unsupervised learning may be a method through which the neural network 100 autonomously learns the connection weights using only input data without applying a target value. In the unsupervised learning, the connection weights are updated based on a correlation between the input data.

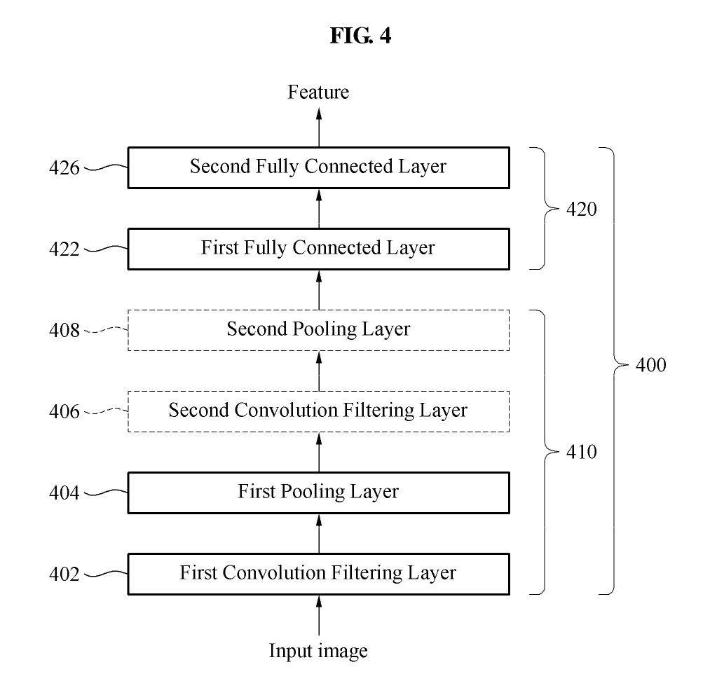

The neural network 100 may include a deep convolutional neural network (DCNN) corresponding to the artificial neural network. Descriptions related to the DCNN will be provided in detail with reference to FIG. 4.

The feature extraction model 110 may be, for example, a model extracting a feature from the input data. The input data may include a video representing a dynamic motion of a user and/or a stationary image of the user. For example, the input data may include events generated from a dynamic vision sensor (DVS), a frame generated from a complementary metal-oxide semiconductor (CMOS) image sensor (CIS), and/or a depth image generated from a depth sensor. For example, the depth image may be received from a time-of-flight (ToF)-based depth sensor or from a structured light-based depth sensor.

The feature extraction model 110 may be learned before a use of the neural network 100. Layers included in the feature extraction model 110, nodes included in the layers, and connection weights of the nodes may be learned and determined in advance.

The classification model 120 may be, for example, a model classifying the input data based on the feature. The classification model 120 may include nodes corresponding to an item to be finally classified, to the output layer. The classification model 120 may classify the input data based on a node having a greatest output value among values output from the nodes.

The feature input to the classification model 120 may be extracted from an input image including a user, and the nodes may correspond to pre-registered users. The classification model 120 may identify the user included in the input image by classifying the input image into one of the nodes in the output layer. In the present disclosure, for increased clarity and conciseness, the terms “node of an output layer” and “element included in the output layer” may be interchangeably used since they share the same meaning.

The classification model 120 may be learned based on a feature track xᵢ including features extracted from an image including a predetermined user. A feature track may be, for example, a set of features to be processed through a grouping based on a time at which the input data is input. The classification model 120 learned based on the feature track xᵢ may output a probability that a user corresponding to an input feature track matches the predetermined user.

As an example, when a feature track xⱼ is input to the classification model 120, the classification model 120 may calculate a similarity between the feature track xᵢ and the feature track xⱼ, and verify whether the user of the feature track xᵢ matches a user of the feature track xⱼ.

When the similarity is greater than a threshold, the classification model 120 may verify the user of the feature track xᵢ matching the user of the feature track xⱼ as the same user. The threshold may be predetermined. Conversely, when the similarity is less than or equal to the threshold, the classification model 120 may verify that the user of the feature track xᵢ does not match the user of the feature track xⱼ and the user of the feature track xᵢ differs from the user of the feature track xⱼ.

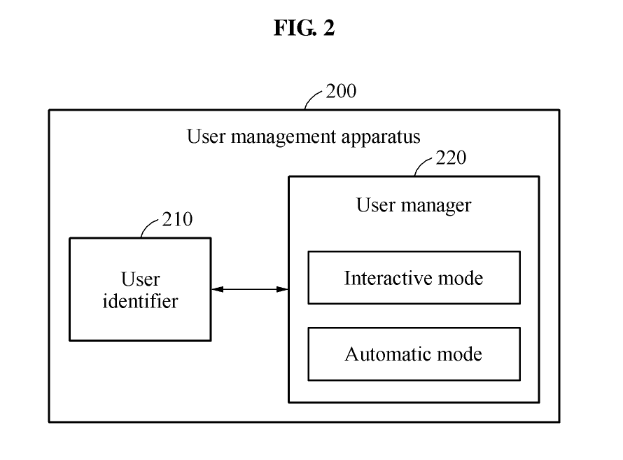

FIG. 2 illustrates a user management apparatus according to an exemplary embodiment.

Referring to FIG. 2, a user management apparatus 200 may recognize and authenticate a user included in an input image. The user management apparatus 200 may include a user identifier 210 and a user manager 220. The user management apparatus 200 may recognize the user included in the input image and authenticate whether the recognized user corresponds to a pre-registered user.

The user management apparatus 200 may be implemented as a software module, a hardware module, or a combination thereof. The user management apparatus 200 may be embedded in various computing devices and/or systems, for example, a smartphone, a tablet computer, a lap-top computer, a desk-top computer, a television, a wearable device, a security system, or a smart home system.

The user identifier 210 may identify the user included in the input image based on a classification model. The input image may include a video representing a dynamic motion of a user and/or a stationary image of the user. For example, the input image may include events generated from a DVS, a frame generated from a CIS, and/or a depth image generated from a depth sensor. The classification model may be, for example, a model classifying a registered user. The classification model may classify the input image as a registered user based on the feature extracted from the input image.

The user identifier 210 may output a result obtained by identifying the user included in the input image. For example, the user identifier 210 may output at least one of a user identification (ID) indicating the user included in the input image as an identification result, a feature track extracted from the input image, an identification probability, and time information. The user ID may be information used to identify the user included in the input image. For example, the user ID may include ID information on the registered user when the user included in the input image is the registered user, and the user ID may include ID information indicating the user is a non-registered user when the user differs from the registered user. The identification probability may be, for example, a probability that the user included in the input image is recognized as a predetermined user. The time information may be information indicating a time at which the input image is acquired, and may include, for example, information indicating an initiation time and a termination time of the feature track. The identification result output from the user identifier 210 may be stored in a database.

The user manager 220 may process the identification result output from the user identifier 210. For example, when the user included in the input image differs from the registered user, and when a threshold condition is satisfied, the user manager 220 may register the user included in the input image. The threshold condition may be predetermined. When the user included in the input image is the registered user, and when the threshold condition is satisfied, the user manager 220 may update the classification model by using the input image. When the threshold condition is satisfied, the user manager 220 may remove a pre-registered user.

The user manager 220 may operate in an interactive mode or an automatic mode. In the interactive mode, the user manager 220 may process the identification result output from the user identifier 210 based on an input of a user command. In the automatic mode, the user manager 220 may process the identification result output from the user identifier 210 irrespective of the input of the user command.

The user manager 220 may change the classification model by processing the identification result. The changed classification model may be transmitted to the user identifier 210. The user identifier 210 may identify the user included in the input image based on the changed classification model, thereby verifying whether the user included in the input image is the registered user.

Hereinafter, for increased clarity and conciseness, the classification model used before the changing may also be referred to as, a first classification model, and the changed classification model may also be referred to as, for example, a second classification model.

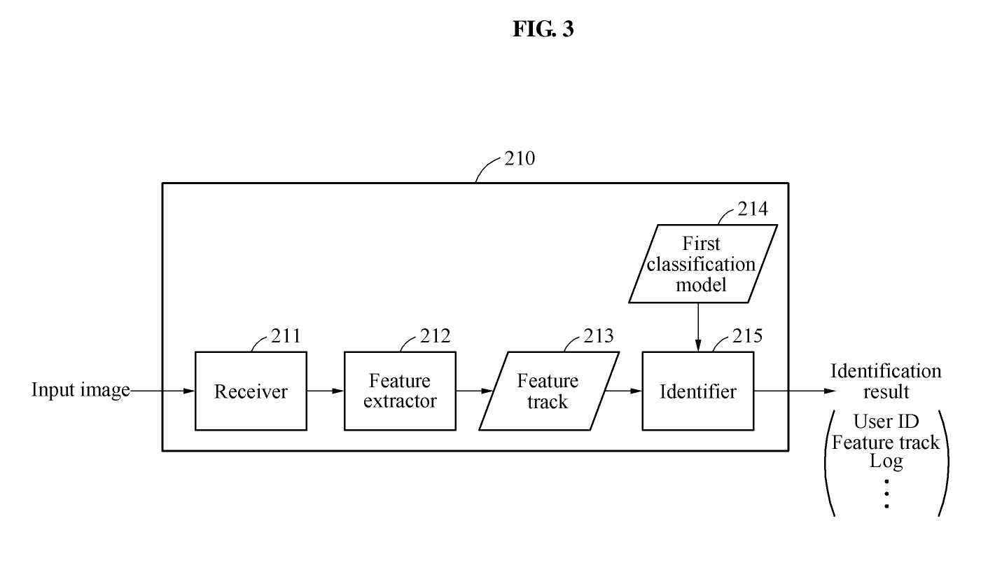

FIG. 3 illustrates a user identifier of a user management apparatus according to an exemplary embodiment.

Referring to FIG. 3, the user identifier 210 may include a receiver 211, a feature extractor 212, and an identifier 215. The user identifier 210 may identify a user included in an input image, thereby verifying whether the user is a registered user.

The receiver 211 may receive an input image. The input image may include a video representing a dynamic motion of a user and/or a stationary image of the user. For example, the input image may include events generated from a DVS, a frame generated from a CIS, and/or a depth image generated from a depth sensor.

The feature extractor 212 may extract a feature from the input image. When the input image includes the events generated from the DVS, the feature extractor 212 may extract the feature by converting the event into one frame. For example, pixels included in the one frame may indicate a number of events occurring in a corresponding position or a value of a most recently occurring event.

The feature extractor 212 may detect and track the user included in the input image. The feature extractor 212 may extract a boundary box including the user from the input image, and track the user based on the boundary box.

The feature extractor 212 may extract a feature of the tracked user. The feature extractor 212 may extract the feature of the user included in the input image based on a pre-learned feature extraction model. The pre-learned feature extraction model may include, for example, a DCNN.

The feature extractor 212 may select one of features obtained through an extraction. The feature extractor 212 may select a feature to be used for identifying a user from the features. As an example, the user included in the input image may be identified based on a face. From the features, the feature extractor 212 may select a feature corresponding to the face of the user and may not select other features. As another example, the user included in the input image may be identified based on a motion of the user. From the features, the feature extractor 212 may select a feature corresponding to the motion of the user and may not select other features. Hereinafter, for increased clarity and conciseness, the following descriptions will be provided based on an example of identifying a user based on a face of the user. However, the present disclosure is also applicable to an example of identifying a user based on a motion of the user. Other features and types of features are also contemplated.

The feature extractor 212 may generate a feature track 213 by grouping features extracted and selected from the input image based on a reference. The reference may be predetermined. The feature rack 213 may be, for example, a set of consecutive features extracted from the input image. For example, the feature extractor 212 may generate the feature track 213 by grouping the features extracted from the input image based on a time at which the input image is acquired. Thus, a single feature track may include features corresponding to consecutive images of a predetermined user.

The first classification model 214 may be a model classifying the input image based on the feature track 213. The first classification model 214 may include, for example, a fully connected layer including an output layer including elements corresponding to the registered user and a feature layer to which the feature track 213 is input. The first classification model 214 may output a probability that the user included in the input image is the registered user corresponding to the elements. The first classification model 214 may classify the input image based on an element having a greatest probability among probabilities of the elements.

The identifier 215 may identify the user included in the input image based on the feature track 213 and the first classification model 214. The identifier 215 may input the feature track 213 to the first classification model 214. The identifier 215 may classify the input image using one of the elements based on an output value of the first classification model 214, thereby identifying the user included in the input image as one of registered users. The identifier 215 may output, for example, a user ID, a feature track, and a log, as an identification result. The log may include an identification probability and time information. The identification probability may be, for example, a probability that the user included in the input image is recognized as a predetermined user. The time information may indicate a time at which the input image is acquired, and include, for example, information indicating an initiation time and a termination time of a feature track.

As an example, when the first classification model 214 learns three registered users, the first classification model 214 may output “a value of a first registered user, a value of a second registered user, a value of a third registered user”. For example, the values may be [0.2, 0.8, 0.1]. As shown in the example [0.2, 0.8, 0.1] when the input image includes the second registered user, the first classification model 214 may output, as the greatest value, a probability value corresponding to the registered user verified to be the most similar. The identifier 215 may identify the user included in the input image as the second registered user based on an output value of the first classification model 214. The identifier may output, for example, a second registered user ID, a feature track, and a log, as an identification result. In other words, since the value 0.8 for the second registered user is highest, the identifier 215 identifies the input user as the second registered user, rather than the first registered user or the third registered user since the values 0.2 and 0.1, respectively, for the first and third registered users are lower and hence the input user is less similar to the first and third registered users.

The identification result output from the user identifier 210 may be stored in the database. When the user included in the input image is a registered user, the database may store the identification result until the registered user is removed. Conversely, when the user included in the input image is a non-registered user, the database may store the identification result for a period of time. The period of time may be predetermined. The identification result stored in the database may be used when the user manager 220 of FIG. 2 changes the first classification model. Depending on an example, the database may be included in the user management apparatus, or disposed externally to the user management apparatus and connected to the user management apparatus via a wired connection or a wireless connection.

FIG. 4 illustrates a feature extraction model extracting a feature from an input image according to an exemplary embodiment.

Referring to FIG. 4, a feature extraction model may include a DCNN 400, and the DCNN 400 may include convolution layers 410 and fully connected layers 420. The convolution layers 410 may include a first convolution filtering layer 402 and a first pooling layer 404. However, this is only an example. The convolution layers 410 may include at least one convolution filtering layer and at least one pooling layer. For example, in some exemplary embodiments, the convolution layers 410 may include the first convolution filtering layer 402, the first pooling layer 404, a second convolution layer 406, and a second pooling layer 408.

The first convolution filtering layer 402 may perform convolution filtering on information extracted from a previous layer or an input image using a filter having a predetermined size, for example, 8×8. For example, the first convolution filtering layer 402 may filter a predetermined edge.

As a result of the convolution filtering, a number of filtering images generated may correspond to a number of filters included in the first convolution filtering layer 402. The first convolution filtering layer 402 may include nodes included in the filtering images. Each of the nodes included in the first convolution filtering layer 402 may receive a value obtained through filtering from a size of a region included in a feature image of the previous layer or the input image. The size of the region may be predetermined. The feature image may be, for example, an image generated by performing the convolution filtering based on the number of filters provided in a predetermined size. The number of filters may be predetermined.

A rectifier linear unit (ReLU) may be used as an activation model for each of the modes included in the first convolution filtering layer 402. The ReLU may be, for example, a model outputting “0” in response to an input less than or equal to “0” and outputting a linearly proportional value in response to an input greater than “0”.

The first pooling layer 404 may extract representative values from feature images of the previous layer through pooling. As an example, the first pooling layer 404 may extract a maximum value in an window provided in a predetermined size by sliding at a predetermined interval of the window with respect to each of the feature images, for example, filtering images in a case in which the previous layer is the first convolution filtering layer 402, of the previous layer. In response to the pooling, pooling images corresponding to the feature images may be generated. The first pooling layer 404 may include nodes included in the pooling images. Each of the nodes included in the first pooling layer 404 may receive a value obtained through a pooling from a predetermined size of region in a corresponding feature image. For example, the first pooling layer 404 may extract representative values from information corresponding to the input image on which the filtering is performed.

In the first convolution filtering layer 402 and the first pooling layer 404, nodes between neighboring layers may be partially connected and share a connection weight.

In an example, filters of a second convolution filtering layer 406 may filter out a complicated edge when compared to filters of the first convolution filtering layer 402. In a second pooling layer 408, through a pooling, representative values may be extracted from filtering images on which a filtering is performed by the second convolution filtering layer 406.

As described above, from the second convolution filtering layer 406 and the second pooling layer 408, feature information having a higher complexity in comparison to the first convolution filtering layer 402 and the first pooling layer 404 may be extracted. Additionally, feature information extracted from layers may have a higher complexity by passing a greater number of convolution filtering layers and a greater number of pooling layers.

The fully connected layers 420 may include a first fully connected layer 422 and a second fully connected layer 426. Each of the fully connected layers 420 may include nodes fully connected between neighboring layers, and a connection weight of the nodes may be set individually. A model regularization algorithm, for example, a dropout, may be applied to the fully connected layers 420. The dropout may be an algorithm that a ratio of nodes, for example, 50% of nodes, are randomly absent from learning in a current learning epoch. The ratio of nodes may be predetermined.

In FIG. 4, the feature extraction model may be pre-learned before the user management apparatus receives the input image. The feature extraction model may output a feature for identifying more users in comparison to a classification model to be described hereinafter.

The configuration of the DCNN 400 is described as an example with reference to FIG. 4 and thus, the convolution layers 410 and the fully connected layers 420 may be provided in various forms irrespective of a DCNN configuration and a recognition purpose.

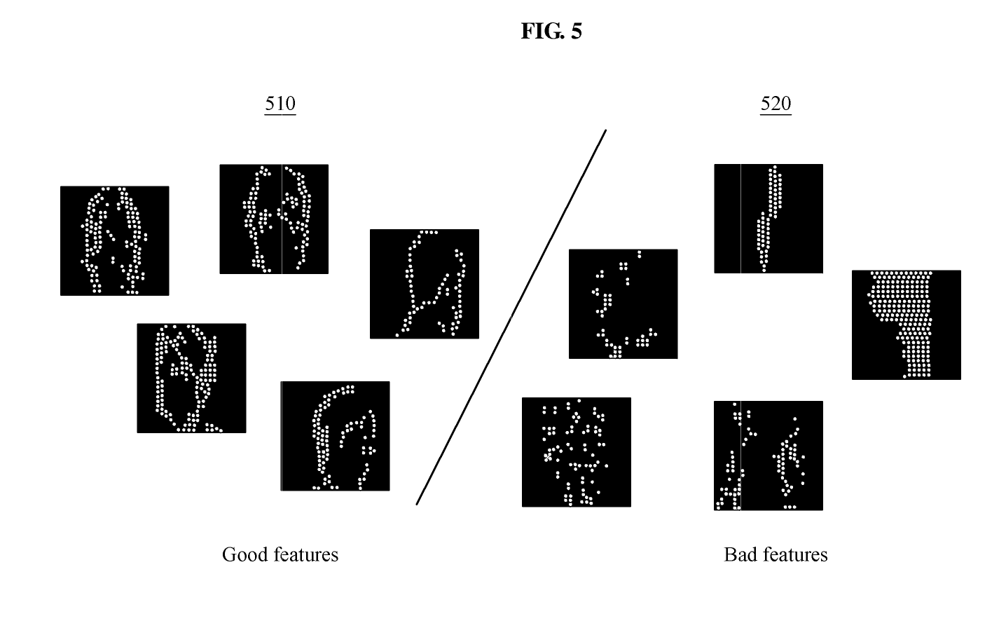

FIG. 5 illustrates an example of selecting a feature by using a feature extractor according to an exemplary embodiment.

In an example, the user identifier may identify a user based on a face of the user included in an input image. A feature extractor may be included in the user identifier to select a feature based on whether the face of the user included in the input image is appropriate for identifying the user. For example, from extracted features, the feature extractor may select a feature 510 corresponding to the face of the user and exclude a feature 520 not corresponding to the face. The feature extractor may select the feature based on a feature extraction model learned to select the feature corresponding to the face of the user.

In another example, the user identifier may identify a user based on a motion of the user included in an input image. In this example, the feature extractor may select a feature based on whether the motion of the user included in the input image is appropriate for identifying the user. For example, from extracted features, the feature extractor may select a feature corresponding to the motion of the user and exclude a feature not corresponding to the motion. The feature extractor may select the feature by using a feature extraction model learned to select the feature corresponding to the motion of the user.

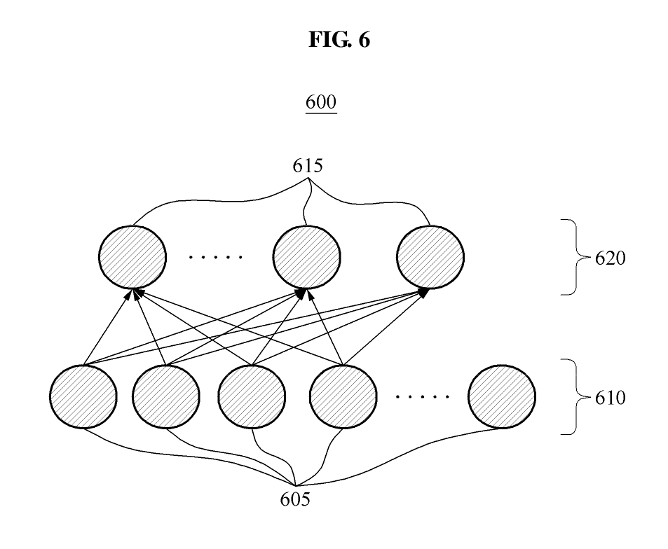

FIG. 6 illustrates a classification model according to an exemplary embodiment.

Referring to FIG. 6, a classification model 600 may include fully connected layers including a feature layer 610 and an output layer 620. The feature layer 610 may receive features included in a feature track. Nodes 605 included in the feature layer 610 may be fully connected to nodes 615 included in the output layer 620, and a connection weight of the nodes may be set individually.

The output layer 620 may include nodes 615 corresponding to registered users, and the nodes 615 may output a probability that a user corresponding to a feature input to the feature layer 610 is a corresponding registered user. The classification model 600 may identify the user corresponding to the feature input to the feature layer 610 based on an output value of elements included in the output layer 620.

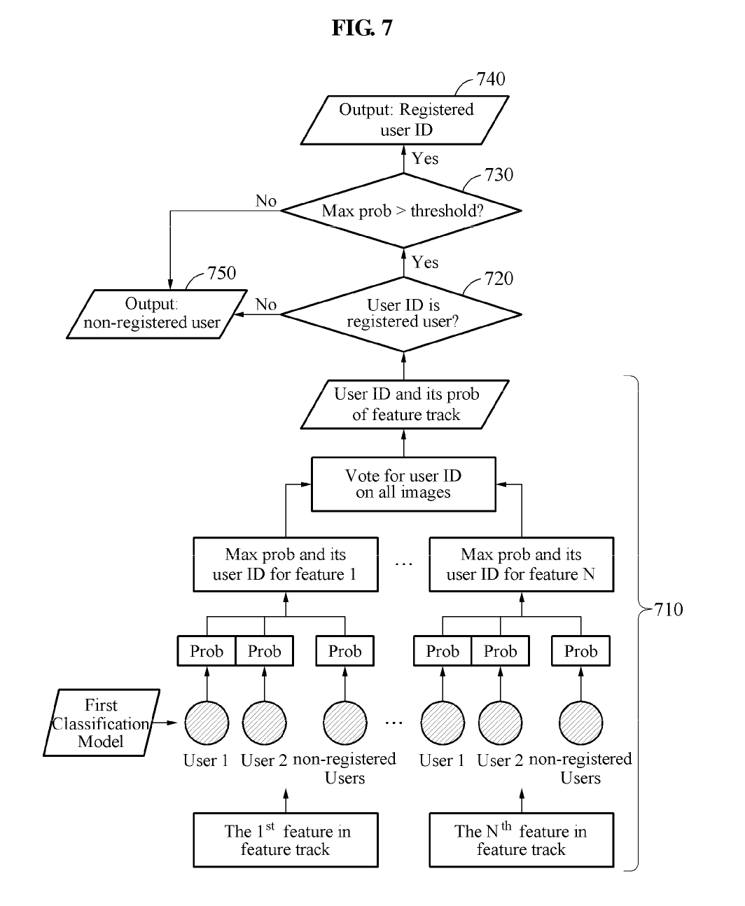

FIG. 7 illustrates a method of identifying a user included in an input image using an identifier according to an exemplary embodiment.

In operation 710, the identifier may verify whether a user corresponding to a feature track is a registered user by identifying the user based on a first classification model.

An output layer of the first classification model may include elements corresponding to registered users and an element corresponding to a non-registered user. The elements included in the output layer may output a probability that a feature input to the first classification model is of a user corresponding to a corresponding element. As an example, when the feature input to the first classification model corresponds to a second registered user, a greatest probability value may be output as an element corresponding to the second registered user. As another example, when the feature input to the first classification model corresponds to the non-registered user, the greatest probability value may be output as an element corresponding to the non-registered user.

The feature track may include a feature corresponding to consecutive images of a predetermined user. The identifier may input the features included in the feature track to the first classification model, and verify elements outputting the greatest probability value corresponding to a corresponding feature in the first classification model.

As an example, the identifier may verify an element outputting the greatest probability value corresponding to a first feature included in the feature track, thereby acquiring a user ID corresponding to the element and a probability value output from the element. Similarly, the identifier may verify an element outputting the greatest probability value corresponding to an N^{th} feature included in the feature track, thereby acquiring a user ID corresponding to the element and a probability value output from the element. The identifier may conduct voting on the acquired user IDs, thereby labeling a user ID elected by a largest number of votes as the feature track. The identifier may acquire an identification probability of a user corresponding to the feature track based on the acquired probability values. The identification probability may be, for example, a probability that the user included in the input image is recognized as a predetermined user.

In operation 720, the identifier may verify whether the user ID of the feature track indicates the registered user. When the user ID of the feature track indicates one of the registered users, the identifier may verify the user corresponding to the feature track as the registered user. Also, when the user ID of the feature track indicates the non-registered user, in operation 750, the identifier may verify that the feature track corresponds to the non-registered user, and output information indicating a result of the verifying by using the user ID.

In operation 730, when the user ID of the feature track indicates the registered user (operation 720: Yes), the identifier may verify whether the identification probability of the user corresponding to the feature track is greater than a threshold. The threshold may be predetermined.

In operation 740, when the identification probability is greater than the threshold (operation 730: Yes), the identifier may verify that the feature track corresponds to the registered user, and output the user ID.

Conversely, when the identification probability is less than or equal to the threshold (operation 730: No), in operation 750, the identifier may verify that the feature track corresponds to the non-registered user, and output information indicating a result of the verifying.

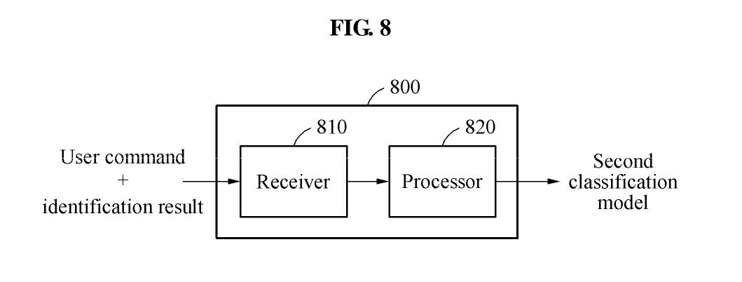

FIG. 8 illustrates a user manager operating in an interactive mode according to an exemplary embodiment.

Referring to FIG. 8, a user manager 800 operating in the interactive mode may include a receiver 810 and a processor 820. The user manager 800 operating in the interactive mode may process an identification result received from a user identifier based on a command input by a user.

The receiver 810 may receive the identification result from the user identifier 210 of FIG. 2. The identification result received by the receiver 810 may include a user ID and a feature track. Also, the receiver 810 may receive a command from a user. A user command may refer to, for example, a command relating to a processing of the identification result. The user command may include for example, registering a new user, removing an existing user, and updating a classification model.

The processor 820 may include one or more microprocessors. The processor 820 may process the identification result based on the user command. The processor 820 may change a first classification model based on the user command and generate a second classification model.

When the user command relates to registering a new user, the processor 820 may register the user corresponding to the feature track included in the identification result. As an example, the processor 820 may store the feature track included in the identification result, and change the first classification model such that the input image is classified with respect to the user ID included in the identification result. The processor 820 may add an element indicating the user ID included in the identification result to an output layer of the first classification model and update a connection weight of elements included in the output layer based on feature tracks of pre-registered users and the feature track included in the identification result, thereby generating the second classification model.

When the user command relates to removing an existing user, the processor 820 may remove the user ID included in the identification result from the first classification model. As an example, the processor 820 may change the first classification model such that the input image is not classified with respect to the user ID included in the identification result. The processor 820 may remove the element indicating the user ID included in the identification result from the output layer of the first classification model and update the connection weight of the elements included in the output layer based on feature tracks of remaining registered users, thereby generating the second classification model.

When the user command relates to updating a classification model, the processor 820 may update the first classification model based on the feature track included in the identification result. Additionally, the processor 820 may update the first classification model based on feature tracks of registered users stored in advance. As an example, the processor 820 may update the connection weight of the elements included in the output layer of the first classification model based on the feature track included in the identification result, thereby generating the second classification model. The second classification model may be provided in an identical configuration, for example, including elements of an identical output layer to a configuration of the first classification model. The second classification model may have a connection weight differing from that of the first classification model.

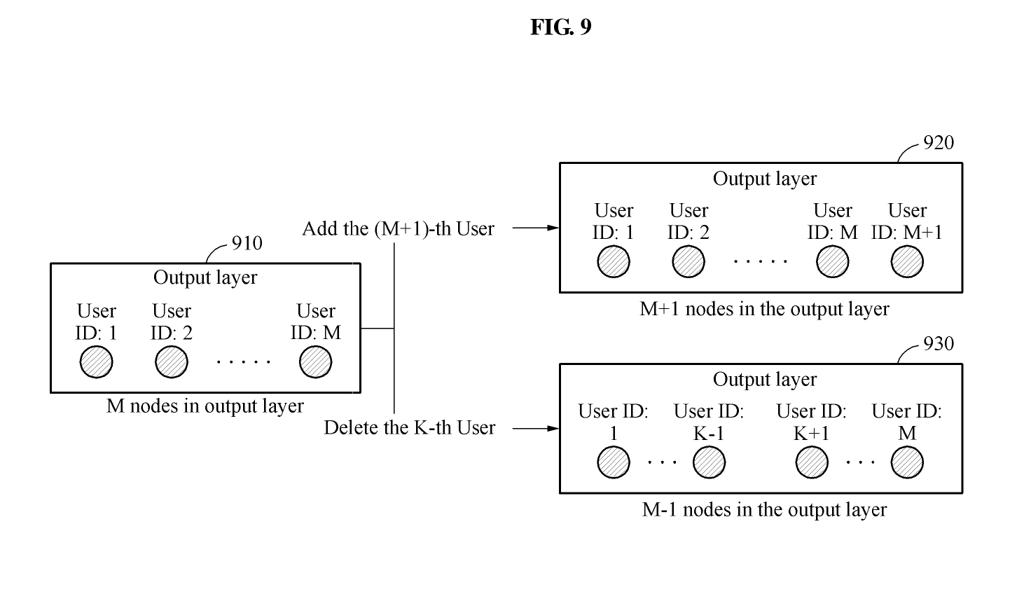

FIG. 9 illustrates an adaptive change in a classification model according to an exemplary embodiment.

Referring to FIG. 9, each of a first classification model 910, a second classification model 920, and a third classification model 930 includes a feature layer and an output layer, and the following description will be provided based on the output layer for increased clarity and conciseness.

The first classification model 910 may be a classification model in an unchanged state. The first classification model 910 may have an output layer including M elements corresponding to registered users.

When a new user is registered, an element corresponding to the new user may be added to the output layer of the first classification model 910 and thus, the second classification model 920 may be generated. The second classification model 920 may have an output layer including M+1 elements corresponding to registered users to which the new user is added. Also, the second classification model 920 may set a connection weight of elements based on a feature track corresponding to the new user and feature tracks corresponding to registered users stored in advance.

When an existing user, for example, a K^{th} registered user, is removed, an element corresponding to the K^{th} registered user may be removed from the output layer of the first classification model 910 and thus, a second classification model 930 may be generated. The second classification model 930 may have an output layer including M−1 elements corresponding to registered users remaining after the removal process. Also, the second classification model 930 may set a connection weight of the M−1 elements based on feature tracks corresponding to the remaining registered users.

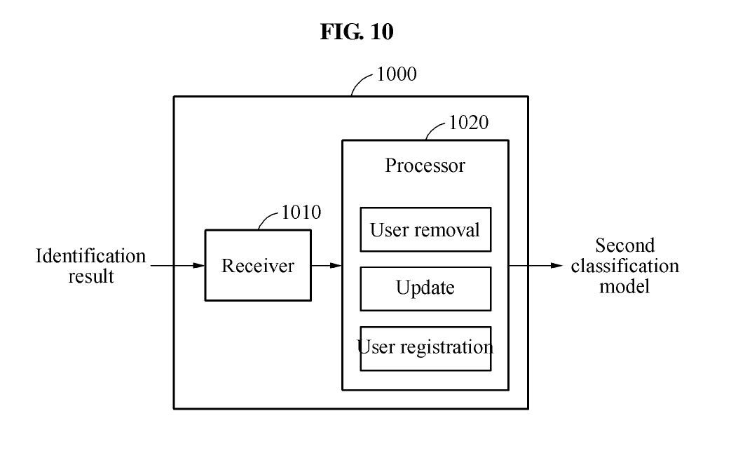

FIG. 10 illustrates a user manager operating in an automatic mode according to an exemplary embodiment.

Referring to FIG. 10, a user manager 1000 may include a receiver 1010 and a processor 1020. In contrast to the interactive mode of FIG. 8, the user manager 1000 may process an identification result received from a user identifier irrespective of an input of a user command in the automatic mode.

The receiver 1010 may receive the identification result from the user identifier 210 of FIG. 2. The identification result may include, for example, a user ID, a feature track, and a log. In this exemplary embodiment, the receiver 1010 does not receive the user command separately. This is because the operation is in automatic mode.

The receiver 1010 may automatically process the identification result. For example, the processor 1020 may remove an existing user based on the identification result, update a classification model, and register a new user.

The processor 1020 may remove the existing user in a case detailed as follows. The processor 1020 may verify a registered user not captured for a threshold period of time based on time information in the log and the user ID included in the identification result. The threshold period of time may be predetermined. The processor 1020 may remove an element corresponding to the verified registered user from an output layer, and set a connection weight of elements included in the output layer based on feature tracks of registered users remaining after the removal process.

For example, a user management apparatus may be a home smart TV and each of users A, B, and C in a family may be a registered user. In this example, when the user B leaves for a long-term business trip abroad, the user management apparatus may verify that the user B is not captured for the threshold period of time. Accordingly, the user management apparatus may remove the user B from the registered users.

The processor 1020 may update the classification model in a case as follows. When a user included in an input image is verified as a registered user, and when an identification probability is less than a threshold, the processor 1020 may update the connection weight included in the first classification model based on the identification result. The threshold may be predetermined. In the present disclosure, for increased clarity and conciseness, the threshold may also be referred to as a second threshold, and the threshold used in operation 730 of FIG. 7 may also be referred to as a first threshold. Also, the second threshold may be greater than the first threshold. Concisely, when the identification probability is relatively low, the processor 1020 may update the connection weight included in the first classification model although the identification probability is sufficient to verify the user included in the input image as the registered user.

The processor 1020 may update the connection weight of the elements included in the output layer of the first classification model based on the feature track included in the identification result, thereby generating the second classification model.

As an example, a face of the registered user may be changed over time due to, for example, hair loss and wrinkles. Since an external change is slowly processed over a long-term period of time, the user management apparatus may identify the registered user with a decreasing identification probability. In this example, the user management apparatus may update the first classification model based on an input image including the registered user having a changing appearance. The user management apparatus may update the connection weight included in the first classification model based on a feature track corresponding to a current input image, and adaptively change the first classification model to recognize the registered user with a relatively high identification probability.

The processor 1020 may register a new user in a case as follows. Although the user included in the input image is verified as a non-registered user, the processor 1020 may register the user when the user frequently appears.

As an example, when the user A returns home from abroad, the user management apparatus, the smart TV, may frequently receive an image including the user A. At first, the user management apparatus may verify the user A as the non-registered user. When the image including the user A is consistently input, the user management apparatus may add the user A as the registered user. In contrast, when the user B stays at home for a short period of time, the user management apparatus may verify the user B as the non-registered user and thus, may not add the user B as the registered user.

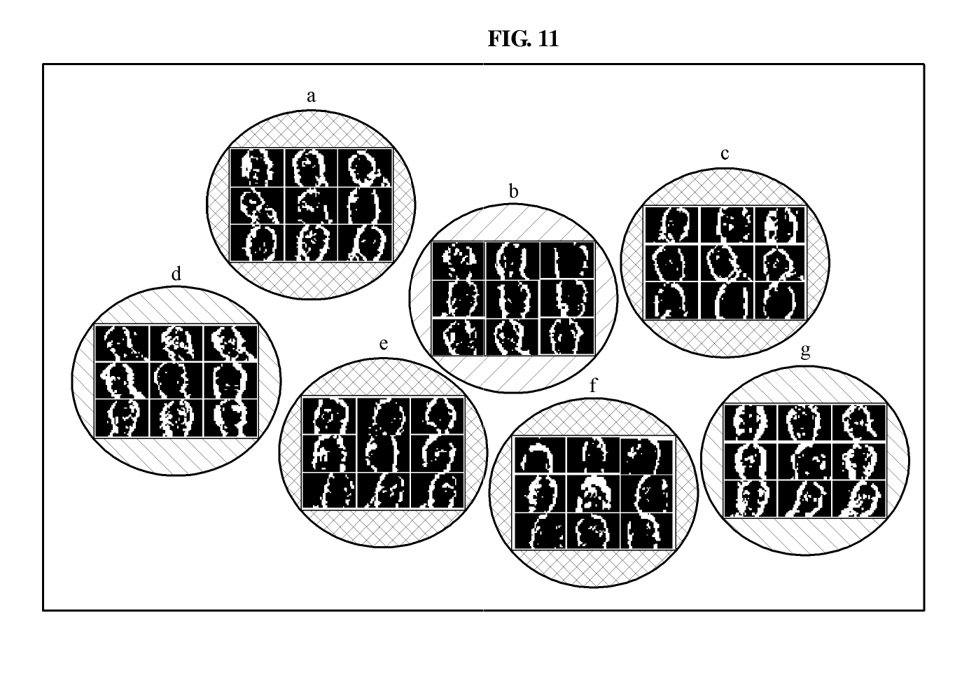

Descriptions related to a procedure of registering a new user using the processor 1020 will be provided in detail with reference to FIGS. 11 through 16.

FIG. 11 illustrates a feature track corresponding to a non-registered user according to an exemplary embodiment.

FIG. 11 illustrates feature tracks “a” through “g” of input images including a user verified as a non-registered user by a user identifier for a threshold period of time. For example, FIG. 9 illustrates each feature track including nine features. That is, for example, feature track “a” includes nine pictures. However, this is only an example, and the number of features is not limited to nine, and may be more or less than nine.

In FIG. 11, for increased clarity and conciseness, feature tracks corresponding to the same user among feature tracks, for example, “a” through “g” may be illustrated as the same background patterns. For example, the feature tracks “a”, “c”, “e”, and “f” having a grid background pattern may correspond to one user. Similarly, the feature tracks “d” and “g” having a background pattern of diagonal lines descending in a rightward direction may correspond to another user.

Referring to FIG. 11, a user corresponding to the grid background pattern may be the most frequently included in an input image during a threshold period of time. Thus, a user manager may register the user corresponding to the grid background pattern. On the other hand, the user manager may recognize that each of the feature tracks of FIG. 11 corresponds to a non-registered user, and may not recognize feature tracks corresponding to the same non-registered user based on a first classification model.

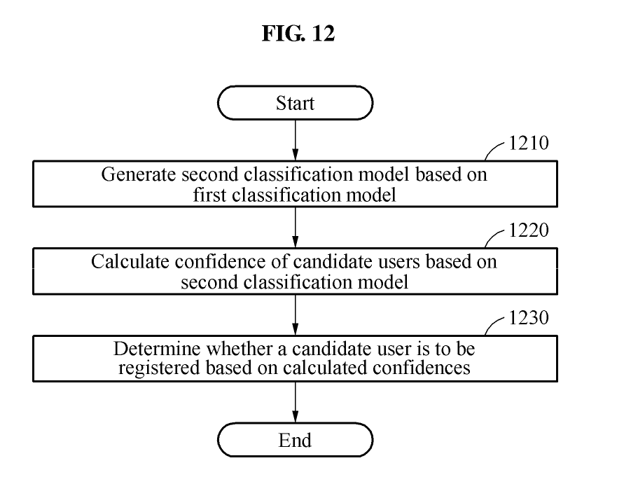

In FIG. 11, each of the feature tracks may be disposed at a predetermined position on a two-dimensional (2D) plane based on a reference. The reference may be predetermined. In this example, when the feature tracks corresponding to the same non-registered user are disposed at a position distinguishable from a position including feature tracks corresponding to different non-registered users, a procedure of registering the user may be performed easily. In general, the feature tracks corresponding to the same non-registered user and the feature tracks corresponding to the other non-registered users may be disposed at positions indistinguishable from one another. In this example, a method of identifying a non-registered user corresponding to the largest number of feature tracks irrespective of a position of a feature track, thereby registering the corresponding non-registered user may be used. Descriptions related to the method will be provided with reference to FIGS. 12 through 16.

FIG. 12 illustrates a procedure of registering a new user by using the user manager of FIG. 10.

A user management apparatus may store an identification result of an input image including a non-registered user for a predetermined period of time in a database. Feature tracks corresponding to a plurality of non-registered users may be stored in the database. Hereinafter, for increased clarity and conciseness, the following description will be provided based on a procedure of registering a candidate user corresponding to one of the non-registered users as an example.

In operation 1210, the user manager may generate a second classification model based on a first classification model. The first classification model may be used to classify pre-registered users, and the second classification model may be used to classify the pre-registered users and a candidate user corresponding to one of non-registered users.

The user manager may generate the second classification model by adding an element indicating the candidate user to an output layer of the first classification model. Additionally, the user manager may set connection weights of elements included in the output layer based on a feature corresponding to a registered user and a feature corresponding to the candidate user. For example, the user manager may set connection weights of the element indicating the candidate user and an element indicating the registered user based on a feature track corresponding to the candidate user and a feature track corresponding to the registered user, thereby generating the second classification model.

In operation 1220, the user manager may calculate confidences of candidate users based on the second classification model. The user manager may calculate a confidence to which features of the non-registered users stored in a database using the second classification model are classified as corresponding to the candidate user. For example, the user manager may calculate the confidence of the user to be higher according to an increase in the number of feature tracks corresponding to the candidate user among the feature tracks stored in the database. Conversely, the user manager may calculate the confidence of the user to be lower according to a decrease in the number of feature tracks corresponding to the candidate user among the feature tracks stored in the database.

In operation 1230, the user manager may determine whether a candidate user is to be registered based on the calculated confidences. For example, the user manager may determined whether a candidate user is to be registered based on the calculated confidences of the non-registered users including the confidence of the candidate user. The user manager may determine whether the candidate user is to be registered based on whether the confidence of the candidate user is a greatest value among the confidences of the non-registered users. When the confidence of the candidate user is the greatest value among the confidences of the non-registered users, the user manager may register the candidate user. For example, although the confidence of the candidate user is the greatest value among the confidences of the non-registered users, the user manager may register the candidate user when the confidence is higher than a threshold confidence. The threshold confidence may be predetermined. When the confidence of the candidate user is not the greatest value among the confidences of the non-registered users, the user manager may determined not to register the candidate user.

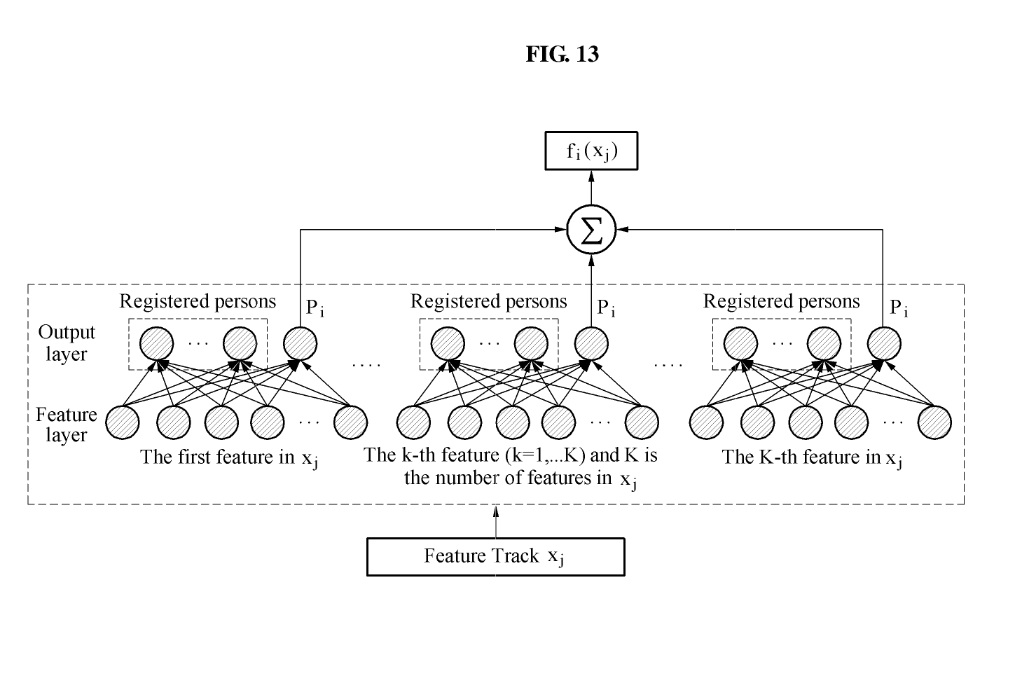

FIG. 13 illustrates a procedure of generating a second classification model based on a first classification model according to an exemplary embodiment.

FIG. 13 illustrates a second classification model generated by adding an element corresponding to a candidate user Pᵢ to an output layer of a first classification model. A connection weight between an output layer and feature layers of the second classification model may be set based on a feature track Pᵢ corresponding to the user xᵢ and feature tracks of registered users. The second classification model may indicate a model classifying a pre-registered user and the candidate user Pᵢ.

The second classification model may receive a plurality of features, for example, K features, included in a feature track xⱼ through the feature layer, and output corresponding identification probabilities from elements included in the output layer. A sum of identification probabilities for example, fᵢ(xᵢ), output from elements corresponding to the candidate user Pᵢ may indicate a similarity between the feature track xᵢ and the feature track xⱼ·fᵢ(xⱼ) may indicate a probability that a user corresponding to the feature track xᵢ is a user corresponding to the feature track xⱼ.

As an example, when the feature track xᵢ and the feature track xⱼ correspond to the same user, fᵢ(xⱼ) may have a relatively high value. Conversely, when each of the feature track xᵢ and the feature track xⱼ corresponds to a different user, fᵢ(xⱼ) may have a relatively low value.

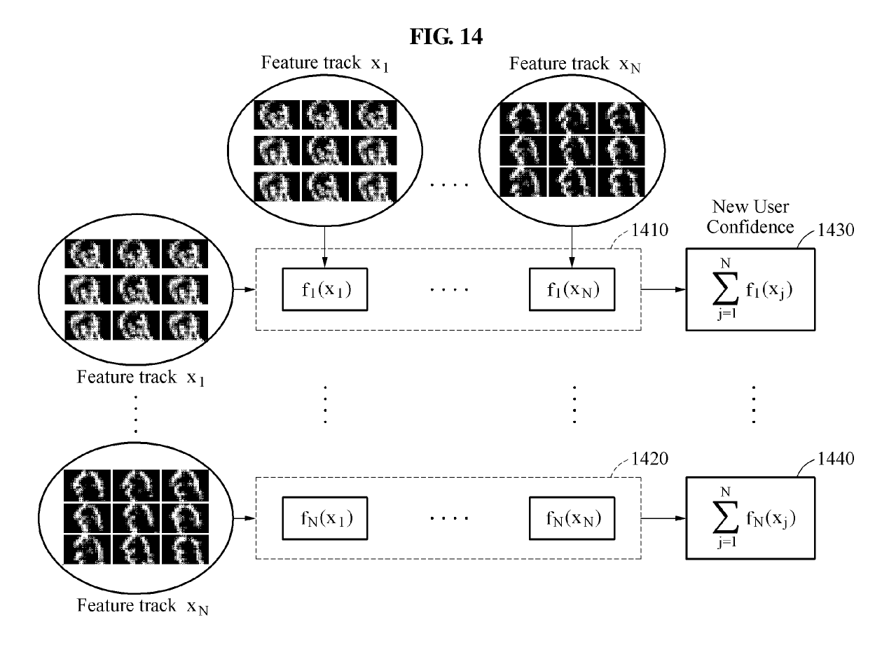

FIG. 14 illustrates a procedure of calculating a confidence of a non-registered user according to an exemplary embodiment.

For increased clarity and conciseness, N features corresponding to non-registered users are assumed to be stored in a database. In this example, the database may include a plurality of feature tracks corresponding to the same non-registered user. A user identifier operating based on a first classification model may identify only registered users to be classified using the first classification model and thus, whether the same user is present in the non-registered users may not be verified.

A confidence 1430 of a first non-registered user (e.g., a new user) corresponding to one of the non-registered users may be calculated as follows. A user manager may generate a second classification model based on a feature track x₁ corresponding to the first non-registered user. In response to an input of feature tracks x₁ through x_{N} of non-registered users, the user manager may calculate similarities 1410 based on values output from the second classification model. The user manager may determine a sum of the similarities 1410 as the confidence 1430 of the first non-registered user.

Similarly, a confidence 1440 of an N^{th} non-registered user corresponding to one of the non-registered users may be calculated based on a sum of similarities 1420 of N non-registered users.

When the first non-registered user is the most frequently included in an input image, a relatively large number of feature tracks corresponding to the first non-registered user may be included in a plurality of feature tracks stored in the database. In this example, the confidence 1430 of the first non-registered user may have a greater value when compared to other non-registered users. Concisely, when the confidence 1430 of the first non-registered user is the greatest value among confidences of the non-registered users, the user manager may register the first non-registered user.

Additionally or alternatively, the user manager may register the first non-registered user based on whether the confidence 1430 of the first non-registered user is greater than a threshold confidence. The threshold confidence may be predetermined. For example, when the confidence 1430 of the first non-registered user is greater than the threshold confidence, the user manager may register the first non-registered user, and transmit the second classification model generated based on the feature track x₁ to the user identifier. The user identifier may verify whether a user included in an image input after the first non-registered user is registered, based on the second classification model.

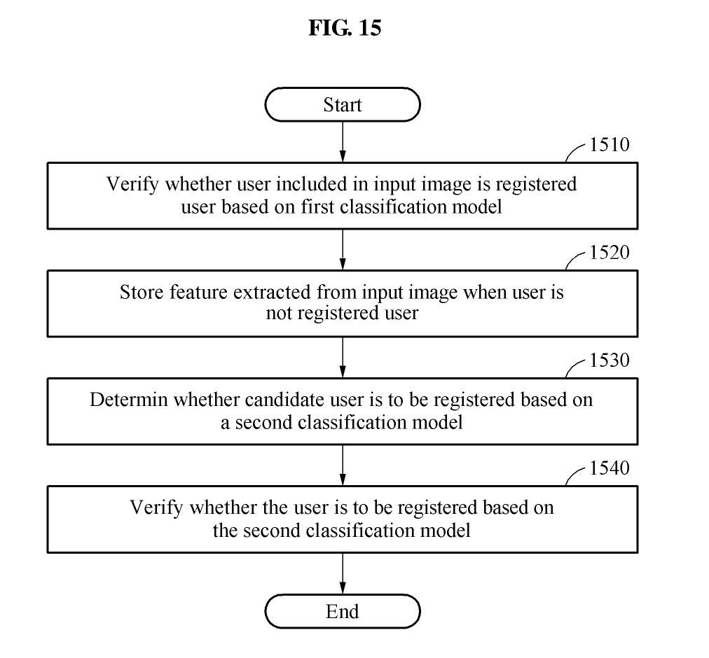

FIG. 15 illustrates a user management method according to an exemplary embodiment.

The user management method may be performed by a processor included in a user management apparatus. The processor may include one or more microprocessors.

In operation 1510, the user management apparatus may verify whether a user included in an input image is a registered user based on a first classification model. The first classification model may be a model classifying the registered user, and may include elements corresponding to the registered user in an output layer. The user management apparatus may classify the input image using one of the elements included in the output layer of the first classification model to identify the user included in the input image, thereby verifying whether the user is the registered user.

In operation 1520, when the user included in the input image is determined to differ from the registered user (i.e., when the user is not a registered user), the user management apparatus may store a feature extracted from the input image in a database. The user management apparatus may store a feature corresponding to a non-registered user in the database based on a predetermined period of time. The user management apparatus may store an identification result of the input image in the database.

In operation 1530, the user management apparatus may generate a second classification model classifying the registered user and a candidate user corresponding to one of features stored in the database, and determine whether the candidate user is to be registered based on the second classification model.

The user management apparatus may determine whether the candidate user is to be registered based on a confidence indicating which of the features stored in the database using the second classification model are classified as corresponding to the candidate user. For example, the user management apparatus may determine whether the candidate user is to be registered based on whether a confidence of the candidate user is the greatest value of confidences of non-registered users corresponding to the features stored in the database. When the confidence of the candidate user is less than a threshold confidence, the user management apparatus may determine that the candidate user is not registered although the confidence of the candidate user is the greatest value of the confidences of the non-registered users.

In operation 1540, when the candidate user is determined to be registered, the user management apparatus may verify whether the user included in the input image is the registered user based on the second classification model.

In an example, in operation 1510, when the user included in the input image is determined to be the registered user, the user management apparatus may update the first classification model using the input image based on an identification probability of the user included in the input image. The user management apparatus may update connection weights of elements included in the output layer of the first classification model based on a feature extracted from the input image.

The input image may include a face of the user corresponding to the input image.

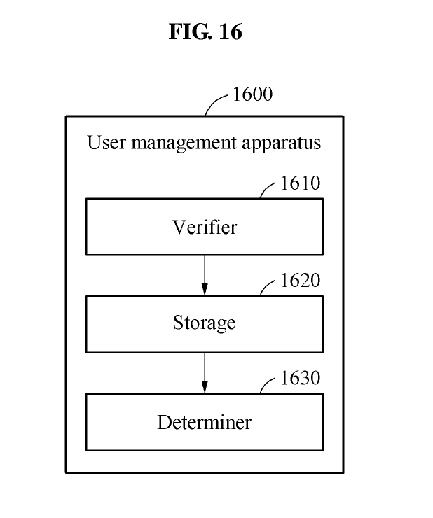

FIG. 16 illustrates a user management apparatus according to an exemplary embodiment.

Referring to FIG. 16, a user management apparatus 1600 may include a verifier 1610, a storage 1620, and a determiner 1630. The verifier 1610 and the determiner 1630 may each be implemented by one or more microprocessors.

The verifier 1610 may verify whether a user included in an input image is a registered user based on a first classification model. The first classification model may be a model classifying the registered user, and may include elements corresponding to the registered user in an output layer.

When the user included in the input image differs from the registered user, the storage 1620 may store a feature extracted from the input image in a database.

The determiner 1630 may generate a second classification model classifying the registered user and a candidate user corresponding to one of features stored in the database, and determine whether the candidate user is to be registered based on the second classification model.

Since the descriptions provided with reference to FIGS. 1 through 15 are also applicable here, repeated descriptions with respect to FIG. 16 will be omitted for increased clarity and conciseness.

According to an aspect of an exemplary embodiment, it is possible to provide technology for automatically performing a user registration procedure by registering a non-registered user included in an input image through identification irrespective of an input of a user command.

According to another aspect of an exemplary embodiment, it is possible to reduce a learning time for registering a new user and effectively improve a recognition accuracy by changing a configuration of a classification model other than a feature extraction model and learning a result of the changing.

The above-described exemplary embodiments may be implemented using hardware components and software components. For example, the hardware components may include microphones, amplifiers, band-pass filters, audio to digital convertors, and processing devices. A processing device may be implemented using one or more general-purpose computers or one or more special purpose computers, such as, for example, a processor, a controller and an arithmetic logic unit, a digital signal processor, a microcomputer, a field programmable gate array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

Methods according to one or more of the above-described exemplary embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

Although a few exemplary embodiments have been shown and described, the present inventive concept is not limited to the described exemplary embodiments. Instead, it would be appreciated by those skilled in the art that changes may be made to these exemplary embodiments without departing from the principles and spirit of the present inventive concept, the scope of which is defined by the claims and their equivalents.

What is claimed is:

1. A user management method comprising:
verifying whether a user included in an input image is a registered user based on a first classification model classifying the registered user;
storing a feature corresponding to the user and extracted from the input image in a database in response to the user not being the registered user; and
generating a second classification model classifying the registered user and a candidate user corresponding to one of features stored in the database; and
determining whether the candidate user is to be registered based on the second classification model.

2. The user management method of claim 1, wherein the generating the second classification model comprises generating the second classification model by adding an element indicating the candidate user to an output layer of the first classification model, and the output layer comprises an element indicating the registered user.

3. The user management method of claim 2, wherein the generating the second classification model further comprises setting connection weights of elements indicating the registered user and the candidate user based on a feature corresponding to the registered user and a feature corresponding to the candidate user.

4. The user management method of claim 1, wherein the generating the second classification model comprises determining whether the candidate user is to be registered based on a confidence indicating a degree to which the features stored in the database using the second classification model are classified as corresponding to the candidate user.

5. The user management method of claim 4, wherein the generating the second classification model further comprises determining whether the candidate user is to be registered based on whether a confidence of the candidate user is a greatest value among confidences of non-registered users corresponding to the features stored in the database.

6. The user management method of claim 5, wherein the generating the second classification model further comprises determining not to register the candidate user in response to the confidence of the candidate user being less than a threshold confidence while the confidence of the candidate user is the greatest value among the confidences of the non-registered users.

7. The user management method of claim 1, wherein, in response to a determination that the candidate user is to be registered, verifying whether a user included in an image input after the determination is the registered user based on the second classification model.

8. The user management method of claim 1, further comprising updating the first classification model by using the input image based on an identification probability of the user included in the input image in response to the user being verified as the registered user.

9. The user management method of claim 8, wherein the updating the first classification model comprises updating connection weights of elements included in an output layer of the first classification model based on the feature extracted from the input image.

10. The user management method of claim 1, wherein the feature extracted from the input image is processed through a grouping based on a time at which the input image is acquired.

11. The user management method of claim 1, wherein the input image comprises a face of a user corresponding to the input image.

12. A user management method comprising:
generating, based on a first classification model classifying a registered user, a second classification model classifying the registered user and a candidate user corresponding to one of a plurality of non-registered users;
determining a confidence of the candidate user and confidences of the plurality of non-registered users, based on the second classification model; and
determining whether the candidate user is to be registered based on the confidences of the non-registered users and the confidence of the candidate user.

13. The user management method of claim 12, wherein the generating the second classification model comprises generating the second classification model by adding an element indicating the candidate user to an output layer of the first classification model, the output layer comprising an element indicating the registered user.

14. The user management method of claim 13, wherein the generating the second classification model further comprises setting connection weights of elements included in the output layer based on a feature corresponding to the registered user and a feature corresponding to the candidate user.

15. The user management method of claim 12, wherein the confidence of the candidate user indicates a degree to which features of the plurality of non-registered users are classified as corresponding to the candidate user based on the second classification model.

16. The user management method of claim 12, wherein the determining whether the candidate user is to be registered comprises determining whether the candidate user is to be registered based on whether the confidence of the candidate user is a greatest value among the confidences of the non-registered users.

17. The user management method of claim 12, further comprising verifying, in response to a determination that the candidate user is to be registered, whether a user included in an image input after the determination is the registered user based on the second classification model.

18. The user management method of claim 12, wherein the non-registered users are users determined to differ from the registered user based on the first classification model among users included in images input during a period of time.

19. A non-transitory computer-readable recording medium storing a computer program that is executable by a computer to implement the method of claim 1.

20. A user management apparatus comprising:
a verifier configured to verify whether a user included in an input image is a registered user based on a first classification model classifying the registered user;
a storage configured to store a feature corresponding to the user and extracted from the input image in a database in response to the user included in the input image not being the registered user; and
a determiner configured to generate a second classification model classifying the registered user and a candidate user corresponding to one of features stored in the database and to determine whether the candidate user is to be registered based on the second classification model.

21. A method for automatically registering a user in an input image, the method including:
determining whether the user included in the input image is a pre-registered user based on a first neural network classification model used to learn one or more pre-registered users;
in response to determining that the user is not one of the one or more pre-registered users, storing a feature corresponding to the user and extracted from the input image;
generating a second neural network classification model for learning a non-registered user corresponding to one of the stored features, wherein the second neural network classification model is based on the first neural network classification model; and
determining whether a candidate user among non-registered users is to be registered based on the second neural network classification model.

22. The method of claim 21, wherein the first neural network classification model and the second neural network classification model each include an output layer and a previous layer to the output layer in a deep convolutional neural network (DCNN).

23. The method of claim 21, wherein the user is registered without a request for registration from the user.

24. The method of claim 21, wherein the second neural network classification model is generated by modifying the first neural network classification model to learn the feature corresponding to the non-registered user.
